(19) United States
(12) Patent Application Publication
(10) Pub. No.: US 2006/0218917 A1
(43) Pub. Date: Oct. 5, 2006

(54) Hydroelectric power plant

(76) Inventor: Afif Abou-Raphael, Gatineau (CA)

Correspondence Address: AFIF ABOU-RAPHAEL, 250 MAISONNEUVE BLV., GATINEAU, QC, J8X 3N8, CA

(21) Appl. No.: 11/091,115

(22) Filed: Mar. 29, 2005

(51) Int. Cl. F03B 17/02

(52) U.S. Cl. 60/495

(57) ABSTRACT

This invention relates to the construction of power plants of the type described in the Canadian patent no 2328580. Each of these plants is placed in a shallow pressurised pool. A number of these plants are connected together with the same pneumatic circuit, in order to use the same flow of compressed gas that enters in the first power plant and exits from the last one of the same series while producing growing energy with the same volume of gas that expends at shallower depth and displaces more liquid for a bigger buoyant force. These pressurized pools when connected together they give conditions of deep depths that permits the transformation of almost all of the potential energy of compressed gases at any pressure. In addition, these pools can be built on the surface, or in recycled ships where the transformation of compressed air produced by compressors, using the abundant and renewable energy of the sea waves is possible.

This invention relates to the construction of a series of power plants according to the methods of the Canadian patent no 2328580 into shallow pressurized pools, built on the surface or in recycled ships.

The subject of this invention is the construction of a number of power plants according to the methods of the Canadian patent no 2328580 into shallow pressurized pools that are connected together with the same pneumatic circuit in order to use the same flow of compressed gas that enters in the first power plant and exits from the last one of the same series while producing growing energy. These pressurized pools when connected together they give conditions of deep depths that permit the transformation of almost all of the potential energy of compressed gases at any pressure into mechanical, electrical energy or else, and they can be built on the surface or in recycled ships where the transformation of compressed air produced by compressors using the abundant and renewable energy of the sea waves is possible. In addition, the low cost of the construction of these power plants into pressurized pools is another advantage of this invention.

The embodiment of this invention includes:

1—The construction of a number of power plants according to the methods of the Canadian patent no 2328580, into shallow pressurized pools, and every one of these power plants of the same series includes:

A pool of liquid covered with a tight cover, except for the last power plant of the same series which does not need a cover, because that the air is dumped directly in the atmosphere,

An upper driving cogwheel wheel placed just below the surface of the pool, rotating in two ball bearing housings attached to the walls of the pool so as to allow the output shaft to pass through the walls without leakage,

A lower cogwheel placed in the bottom of the pool rotating in two multi-purpose ball bearings to facilitate rotation and eliminate axial movements. The ball bearing housings are fastened to the frame of a tensioning device that allows adjustment of the tension of the endless chain. The chain is composed of special links that loop around the upper and lower cogwheels, thereby rotating them. The inner surface of the chain link conforms exactly to the outer surface of the lower cogwheel, thus ensuring a good seal between each chain link and the lower cogwheel. Compressed air from the main tank is forced without leakage into containers as they loop around the lower cogwheel from the lower horizontal to the ascending vertical positions. The rotation of the power plant can be either clockwise or counter clockwise.

Cylindrical containers are fastened to the chain links. Each container has a half cover designed to enhance the buoyant cycle by allowing the compressed air to be injected into it as soon as it comes into the horizontal position on the lower cogwheel. The half cover prevents loss of air until the container advances to an inclined position. Because the injection hole is near the opening of the container, a deflector is used to divert the compressed air toward the closed end of the container to prevent spilling. The air stops flowing into the container just before it begins its ascent toward the upper cogwheel pushed by the buoyant force of the liquid's potential energy. A bevelled opening under the half cover of each container and a protrusion on the exterior of the closed end of the following container fit snugly together. Any rattling due to hard contact between the two containers is eliminated by means of a rubber seal around the protrusion. Several holes near the opening of each container allow liquid to flow out of the container as the compressed air expands gradually during the container's ascent toward the surface. By the time it reaches the upper cogwheel, the container is full of air. The expanding volume of compressed air in each ascending container displaces an equal volume of liquid. The increasing weight of displaced liquid is the cause of the growing buoyancy. Force is equal to the weight of the liquid displaced by the compressed air.

A guiding device fastened to the wall of the pool ensures that the endless chain and its containers travel smoothly in a straight line without whipping or vibrations. The guiding device is essential for the proper functioning of the power plant and, if needed, can also be installed on the descending side of the chain on which the containers are full of liquid.

After the container arrives on the upper cogwheel, it inclines, emptying its air as it passes over the cogwheel. Simultaneously, liquid floods the container by gravity until it reaches the descending vertical position, at which point it's opening is facing directly upward. As the container begins its descent toward the lower cogwheel, it is full of water.

The endless chain provides continuous output to the drive shaft attached to the upper cogwheel as long as the correct quantity of compressed air is injected into each ascending container.

A flywheel attached to the drive shaft ensures that the power plant has continuous and uniform rotation.

A Foucault current electromagnetic brake combined with a gearbox regulates the rotation speed as required for the electrical generator or any other device to be driven by the power plant.

A lubricating system lubricates moving parts as required.

The compressed air injected into the containers with thrust comes from a main tank supplied by one or more of the following:
a) Taylor hydraulic air compressors, popular in the mining industry until approximately 1981: U.S. Pat. Nos. 543,410, 543,311, 543,312, 618,243, and 892,772;
b) Ocean wave air compressors: Canadian Patent No. 541393;
c) Conventional air compressors,
d) Instead of using compressed air from the sources described above, gas produced geothermally from black smokers in the sea bottom or elsewhere can be collected using cones and pipes, then transferred to the main tank of the power plant.

Alternately, the excess pressure of natural gas can be used. In this case, the pool must be covered to avoid leaks. After exiting the containers, the natural gas proceeds normally at an agreed-upon lower pressure.

If required, a secondary air compressor powered by combustion engines or by other means can be used to start the power plant, possibly assisted by a starter.

The total buoyant force of all the containers with thrust determines the overall capacity of the power plant. This is equal to the weight of the liquid displaced by the total volume of air in the containers with thrust expressed in Newton, multiplied by the distance between the centre of the drive shaft and the centre of gravity of each container. This distance is the sum of the radius of the upper cogwheel and the radius of the container expressed in meters, multiplied by 2, multiplied by (pi or 3.1416), multiplied by the number of revolutions per minute (rpm) of the power plant. The result of the foregoing multiplication will be divided by 60 seconds to express the power in watts, and by 746 to express this value in horsepower, (each unit of horsepower being equal to approximately 746 watts). Power=Force (Newton)×(Radius of wheel+Radius of container) meters×2×pi×rpm./(Divided by) (60 sec.×746 watts) horse powers

2—all of the power plants of the same series are connected together with the same pneumatic circuit, in order to work with the same compressed gas flow according to the following:

A—the first of the power plants of the same series that are in pressurized pools receives the highly compressed gas in its ascending containers through its rotary transfer joint as explained in the Canadian patent no 2328580. The volume of the gas inside its ascending containers is affected by the hydrostatic pressure according to the depth of each container, added to the pressure that exerts on the surface of the pool, which is equal to the hydrostatic pressure of all the column of water in all of the following pools of the power plants of the same series, added to the atmospheric pressure. When the ascending containers of this first power plant exhaust their compressed gas at the surface of the first pressurized pool, the actual pressure of the gas becomes the equivalent of its pressure when it was initially injected in the ascending containers at the bottom of its pool minus the hydrostatic pressure of the column of water of the same first pool.

Note: The volume of the containers of every power plant of the same series has to be well calculated in order to contain all of the expended volume of the gas due to lower hydrostatic pressure at shallower depth.

According to Boyle's law, the relation between the volumes and the pressures in this first power plant is as follow:
P1×V1=P2×V2=Constant

Where

P1=(hydrostatic pressure at the first position of the container in the first pool at height (H1)+Pressure that exerts on the surface of the first pool under its tight cover that is equal to: [Atmospheric pressure+(total hydrostatic pressure of the column of water of each pool×the remaining number of pools of the same series)].

P2=(hydrostatic pressure at the second position of the container in the first pool at height (H2)+the pressure that exerts on the surface of the first pool under its tight cover that equals to: [Atmospheric pressure+(total hydrostatic pressure of the column of water of each pool×the remaining number of pools of the same series)].

V1=the volume at height (H1).

V2=the new volume at height (H2)

B—Coming from the first power plant the same gas enters in the ascending containers of the second power plant of the same series through its rotary transfer joint at the pressure that is registered under the tight cover of the first pool.

At the surface of the pool of this second power plant, the pressure of the gas diminishes again the equivalent of the hydrostatic pressure of the column of water of the second pool. Another time the compressed gas continues its way by entering the third power plant through its own rotary transfer joint.

According to Boyle's law, the relation between the volumes and the pressures in this second power plant is as follow:
P1×V1=P2×V2=Constant

P1=(hydrostatic pressure at the first position of the container in the second pool at height (H1)+Pressure that exerts on the surface of the second pool under its tight cover that equals to: [Atmospheric pressure+(total hydrostatic of the column of water of each pool×the remaining number of pools of the same series)].

P2=(hydrostatic pressure at the second position of the container in the second pool at height (H2)+the pressure that exerts on the surface of the second pool under its tight cover that is equal to: [Atmospheric pressure+(total hydrostatic of the column of water of each pool×the remaining number of pools of the same series)].

V1=the volume at height (H1).

V2=the new volume at height (H2)

C—we continue the same way according to the number of power plant with pressurized pools until the last one.

If the series of these power plants taken as an example transforms the potential energy of natural gas, the last power plant will have a tight cover too like the previous ones, in order to collect the natural gas after it exits the ascending containers at a pre-determined pressure to be able to send it back in the local pipeline.

And if compressed air is used instead of natural gas, the last power plant will not have a tight cover like the previous ounces because the air will be dumped directly in the atmosphere.

3—The recycling of old ships into hydroelectric power plants, where the abundant and renewable energy of the sea waves can be exploited to produce the needed compressed air to run these power plants in order to provide electrical power to cities and other locations at medium or low voltage, that lowers the cost of every kWh produced.

In summary, the main advantage of this invention is:

1—To be able to transform almost all of the potential energy of compressed gases into mechanical then electrical or other form of energy, inside economical hydroelectric power plants functioning in series with the same pneumatic circuit that connects all of the above mentioned power plants, in order to allow the same flow of compressed gas, to run them all, while crossing from one power plant to the next, until it exhausts from the last one, and producing growing energy because of the volume of the compressed gas that expands at shallower depth due to low hydrostatic pressure, according to the position of each ascending container, where the buoyant force in every one of these power plants is equal to the weight of the water displaced by the volume of the compressed gas, that is in all of the ascending containers of each power plant.

Depending on site specifications and the output required various components; configurations and dimensions for the embodiment may be combined to achieve the desired results. For a better understanding of this invention and to facilitate its examination, it is represented in the following 13 Figures.

### BRIEF DESCRIPTION OF THE DRAWINGS

1—FIG. 1 is a schematic representation of the power plant A.

2—FIG. 2 is a schematic representation of the power plant B.

3—FIG. 3 is a schematic representation of the power plant C.

4—FIG. 4 is a schematic representation of the power plant D.

5—FIG. 5 is a schematic representation of the power plant E.

6—FIG. 6 is a schematic representation of the power plants A, B, C and D placed in series to transform the potential energy of compressed natural gas.

7—FIG. 7 is a schematic representation of the power plants A, B, C and E placed in series to transform the potential energy of compressed air.

8—FIG. 8 is a schematic representation of a ship transformed into hydroelectric power plant and connected to the main electrical grid.

9—FIG. 9 is a cross-sectional representation along line A-A of FIG. 8.

10—11—FIGS. 10 and 11 are schematic representations of power plants A, B, C and E of a series that transform the potential energy of compressed air. In order to see the illustration they have to be side-by-side, FIG. 11 to the right and FIG. 10 to the left.

12—FIG. 12 is a schematic representation of a power plant built in a recycled ship, showing a situation where the compressed air pressure is high, and a higher hydrostatic pressure is needed.

1—FIG. 13 is a schematic representation of a power plant built in a recycled ship, showing a situation where the compressed air pressure is low, and a low hydrostatic pressure is needed.

When considered with the description herein, the characteristics of the invention are apparent from the accompanying drawings, which exemplify an embodiment of the invention for purposes of illustration only, and in which

In FIG. 1 the compressed gas enters into the ascending containers of the power plant A through the air tank 22, the gas lines 21-A and the rotary transfer joint 18-A-A, in order to transform a part of its potential energy according to the described method in the Canadian patent no 2328580. The ascending containers of the power plant A exhaust their gas A-2 under pressure A-4 shown in the pressure gauge 26-A on the surface A-1 of the pool 1-A under the tight cover A-3. Then the same gas A-2 that has already lost of its pressure the equivalent of the hydrostatic pressure of the column of water of the pool 1-A of the first power plant A, continuous its run and enters in the power plant B of FIG. 2 through the gas line A-7.

In FIG. 2 the compressed gas enters into the ascending containers of the power plant B through the air line A-7, the gas lines 21-B and the rotary transfer joint 18-A-B, in order to transform another part of its potential energy according to the same described method in the Canadian patent no 2328580, but the quantity of energy that is produced in power plant B is bigger then the quantity of energy produced in power plant A, because the expended volume of gas has displaced a bigger volume of liquid in power plant B where the buoyant force is equal to the weight of liquid displaced. The ascending containers of the power plant B exhaust their gas B-2 under pressure B-4 shown in the pressure gauge 26-B on the surface B-1 of the pool 1-B under the tight cover B-3. Then the same gas B-2 that has already lost of its pressure another time the equivalent of the hydrostatic pressure of the column of water of the pool 1-B of the second power plant B, continuous its run and enters in the power plant C of FIG. 3 through the gas line B-7.

In FIG. 3, the compressed gas enters into the ascending containers of the power plant C through the air line B-7, the gas lines 21-C and the rotary transfer joint 18-A-C, in order to transform another part of its potential energy according to the same described method in the Canadian patent no 2328580, but the quantity of energy that is produced in power plant C is bigger then the quantity of energy produced in power plant B, because the expended volume of gas has displaced a bigger volume of liquid in power plant C where the buoyant force is equal to the weight of liquid displaced. The ascending containers of the power plant C exhaust their gas C-2 under pressure C-4 shown in the pressure gauge 26-C on the surface C-1 of the pool 1-C under the tight cover C-3. Then the same gas C-2 that has already lost of its pressure another time the equivalent of the hydrostatic pressure of the column of water of the pool 1-C of the third power plant C, continuous its run and enters in the power plant D of FIG. 4 through the gas line C-7, if the series of the power plants A, B, C, and D is used to transform the potential energy of natural gas under high pressure, or it enters in the power plant E of FIG. 5 through the gas line C-7, if the series of the power plants A, B, C, and E is used to transform the potential energy of a highly compressed air.

In FIG. 4 the compressed natural gas enters into the ascending containers of the power plant D through the gas line C-7, the gas lines 21-D and the rotary transfer joint 18-A-D, in order to transform another part of its potential energy according to the same described method in the Canadian patent no 2328580, but the quantity of energy that is produced in power plant D is bigger then the quantity of energy produced in power plant C, because the expended volume of gas has displaced a bigger volume of liquid in power plant D where the buoyant force is equal to the weight of liquid displaced. The ascending containers of the power plant D exhaust their gas D-2 under pressure D-4 shown in the pressure gauge 26-D on the surface D-1 of the pool 1-D under the tight cover D-3. Then the same gas D-2 that has already lost of its pressure another time the equivalent of the hydrostatic pressure of the column of water of the pool 1-D of the fourth power plant D, continuous its run and enters into the pipeline D-7 of FIG. 4 through the gas line D-5 and the check valve D-6.

In FIG. 5 the compressed air enters into the ascending containers of the power plant E through the air line C-7, the gas lines 21-E and the rotary transfer joint 18-A-E, in order to transform another part of its potential energy according to the same described method in the Canadian patent no 2328580, but the quantity of energy that is produced in power plant E is bigger then the quantity of energy produced in power plant C, because the expended volume of gas has displaced a bigger volume of liquid in power plant E where the buoyant force is equal to the weight of liquid displaced. The ascending containers of the power plant E dump their air E-2 in the atmosphere, it means at the atmospheric pressure E-3.

FIG. 6 shows how the power plants A, B, C and D function with the same flow of natural gas under high pressure. The natural gas enters into the rotary transfer joint 18-A-A of the power plant A, through the lines 21-A coming from the gas tank 22, then into the rotary transfer joint 18-A-B of the power plant B, through the gas lines 21-B coming from power plant A through the gas line A-7, then into the rotary transfer joint 18-A-C of the power plant C, through the gas lines 21-C coming from power plant B through the gas line B-7, then into the rotary transfer joint 18-A-D of the power plant D, through the lines 21-D coming from power plant C through the gas line C-7, then finally into the pipeline D-7 through the gas line D-5 and the check valve D-6.

FIG. 7 shows how the power plants A, B, C and E function with the same flow of highly compressed air. The compressed air enters into the rotary transfer joint 18-A-A of the power plant A, through the air lines 21-A coming from the air tank 22, then into the rotary transfer joint 18-A-B of the power plant B, through the air lines 21-B coming from power plant A through the air line A-7, then into the rotary transfer joint 18-A-C of the power plant C, through the air lines 21-C coming from power plant B through the air line B-7, then into the rotary transfer joint 18-A-E of the power plant E, through the air lines 21-D coming from power plant C through the air line C-7, then finally the free air is dumped in the atmosphere.

FIG. 8 shows a ship 103 transformed into hydroelectric power plant that is connected to the main grid through the transformer 102 and the distribution lines 101.

FIG. 9 shows a ship 103 parked on the sea shore 114 including the air tanks 105, the air line 21 that transits the compressed air to the rotary transfer joints 18-A, the pool 111 of the power plants, the endless chain 37, the cogwheels 35 and 35-A, the containers 19, the water reservoir 110 where the water of the pool 111 drops in by gravity through the water valve 112 in order to reduce the water level in the said pool 111 when the height of the sea waves is less then normal, to permit to the power plant to continue running and producing energy. The water reservoir 109 that is used to rise the level of the water of the pool 111 when the height of the waves is higher, again to permit to the power plant to transform more energy.

FIGS. 10 and 11 when they are put together side-by-side, FIG. 11 to the right and FIG. 10 to the left, they represent a module having 4 power plants A, B, C and E working in series with the same pneumatic circuit that supplies all 4 power plants with the same flow of compressed air. The compressed air is injected initially when it is under full flow pressure in the ascending containers of power plant A through its rotary transfer joint 18-A-A when they loop around the lower cogwheel according to the Canadian patent no 2328580. The compressed air volume in the ascending containers expends at shallower depth all during the ascending run until the air is dumped on the surface A-1 of power plant A. The buoyant force in power plant A is equal to the weight of the water displaced by the total volume of the expended air in all the ascending containers of power plant A.

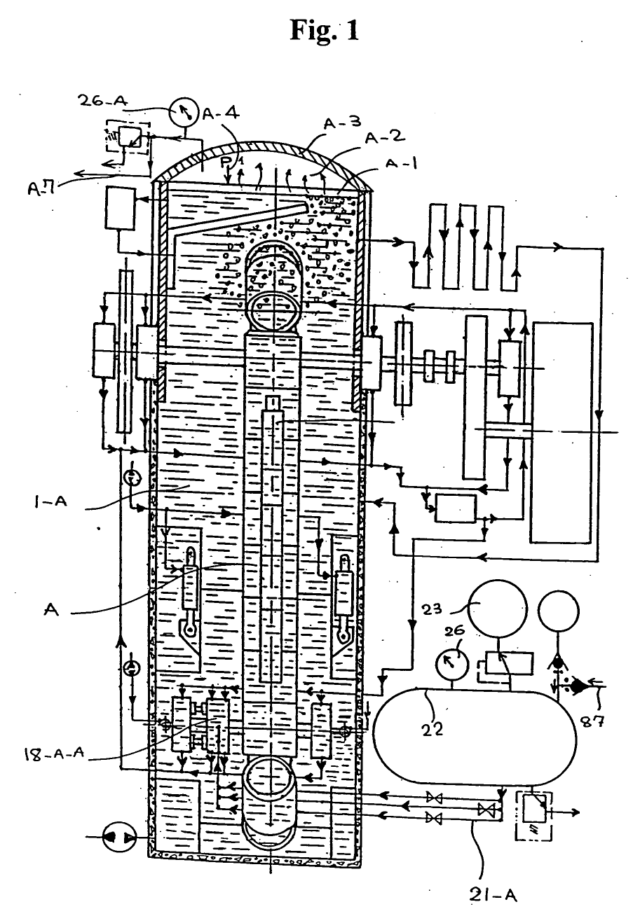

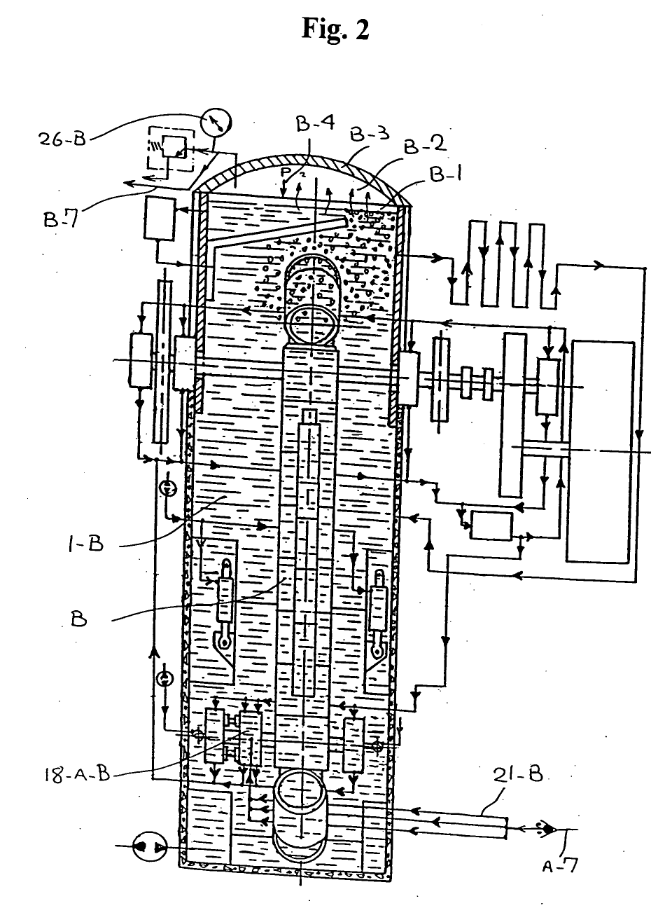

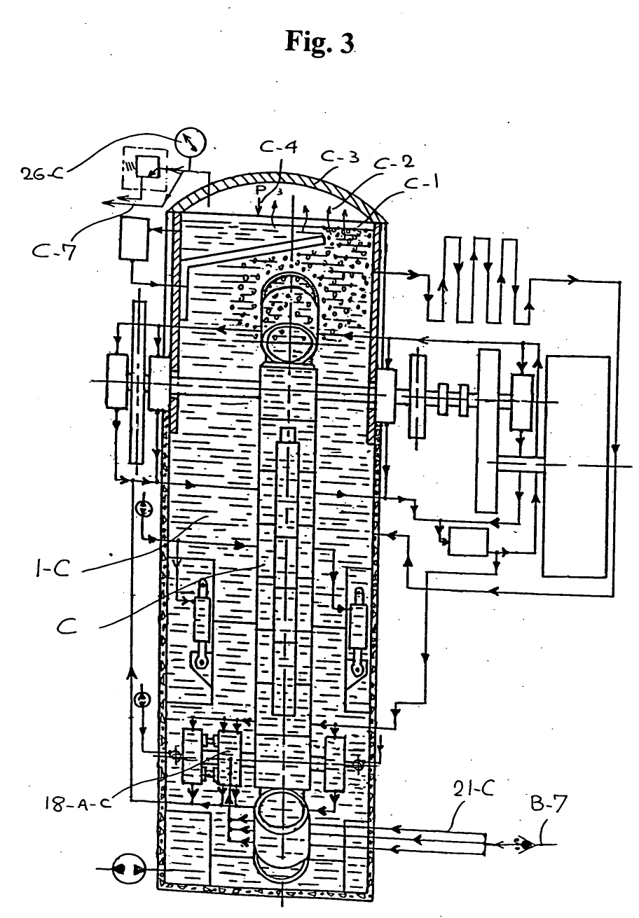

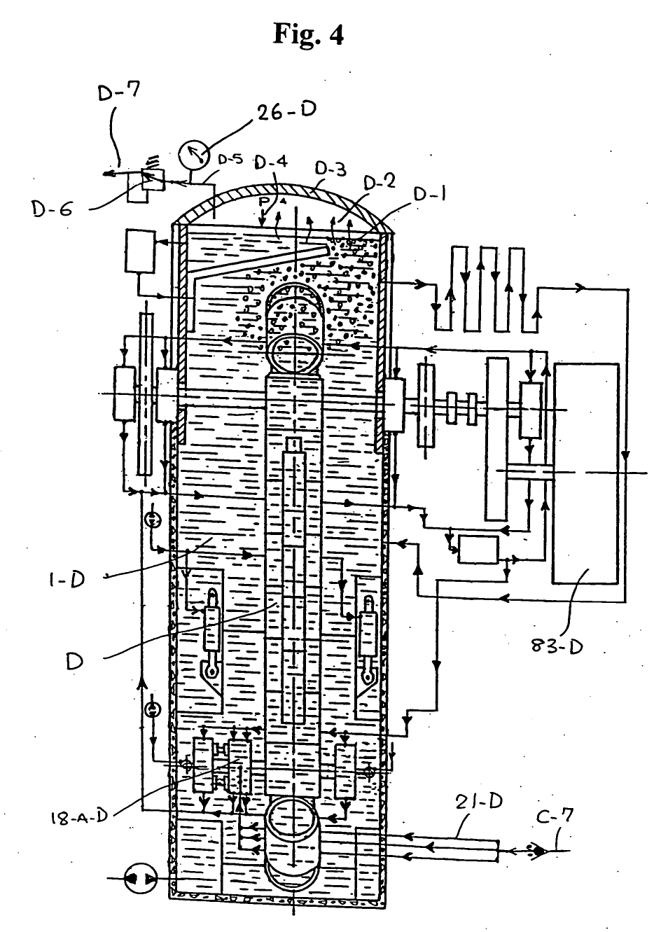

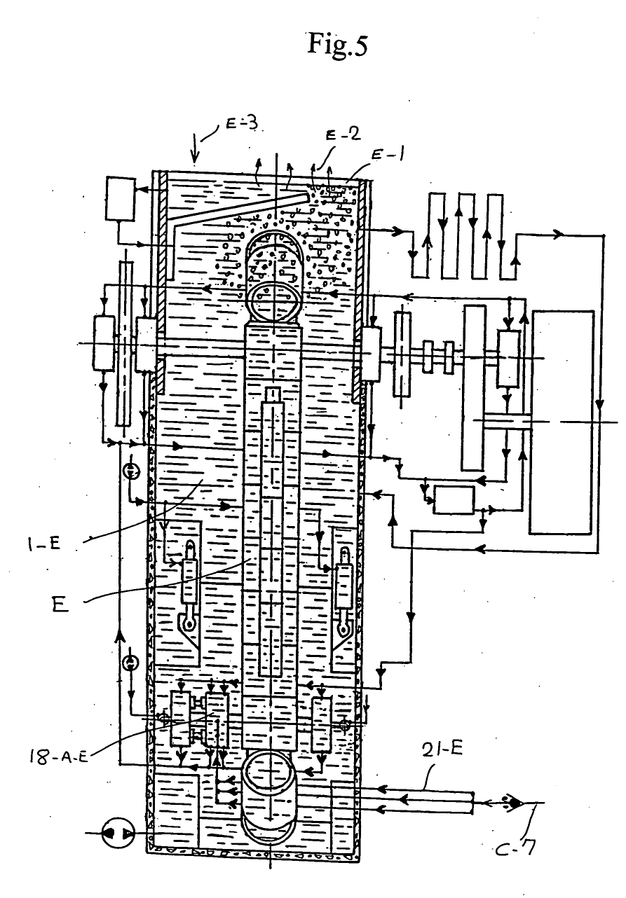

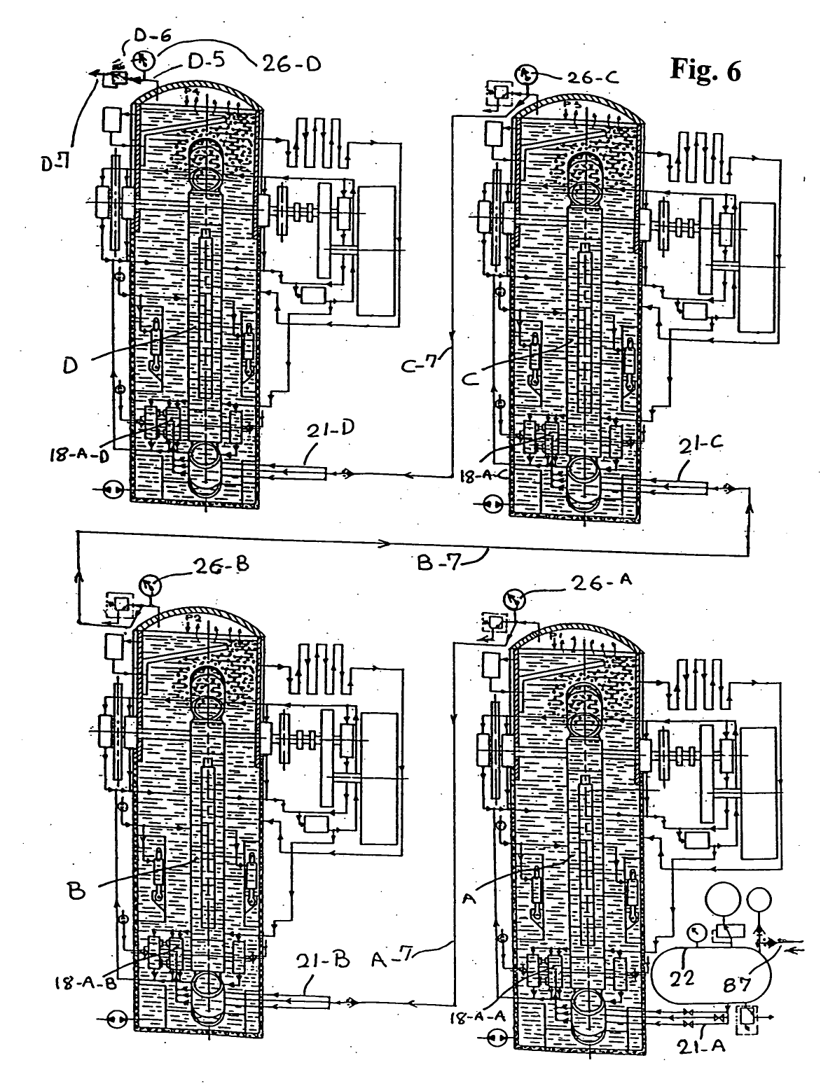

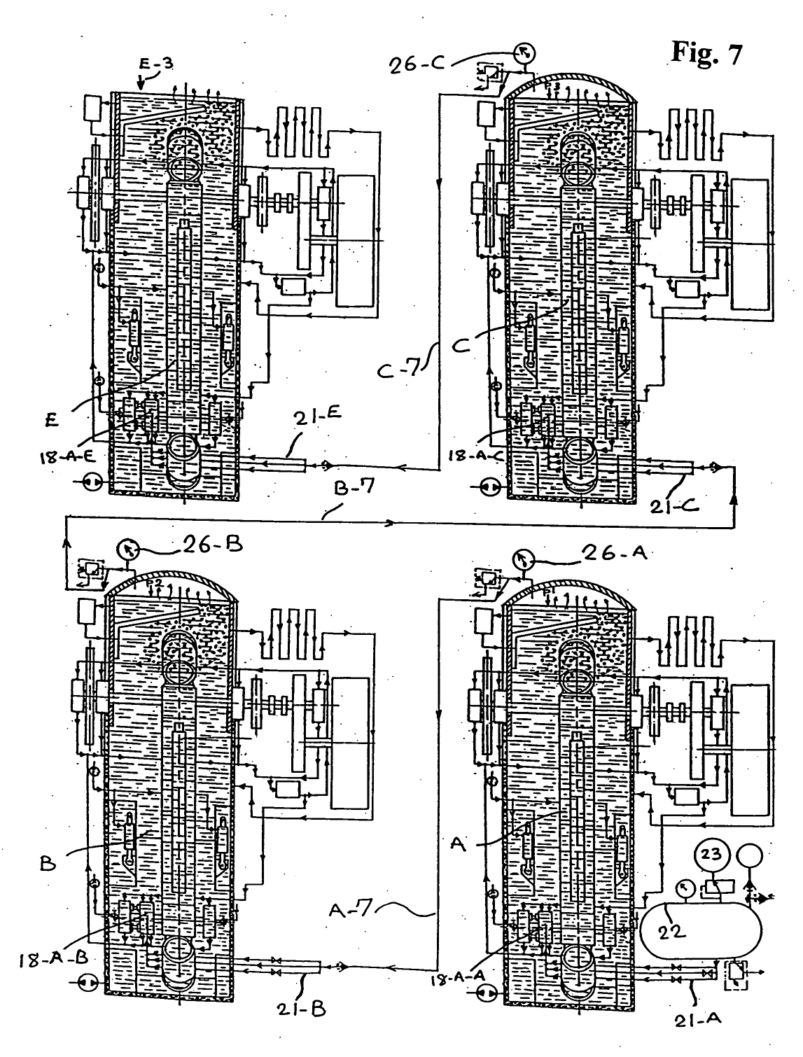

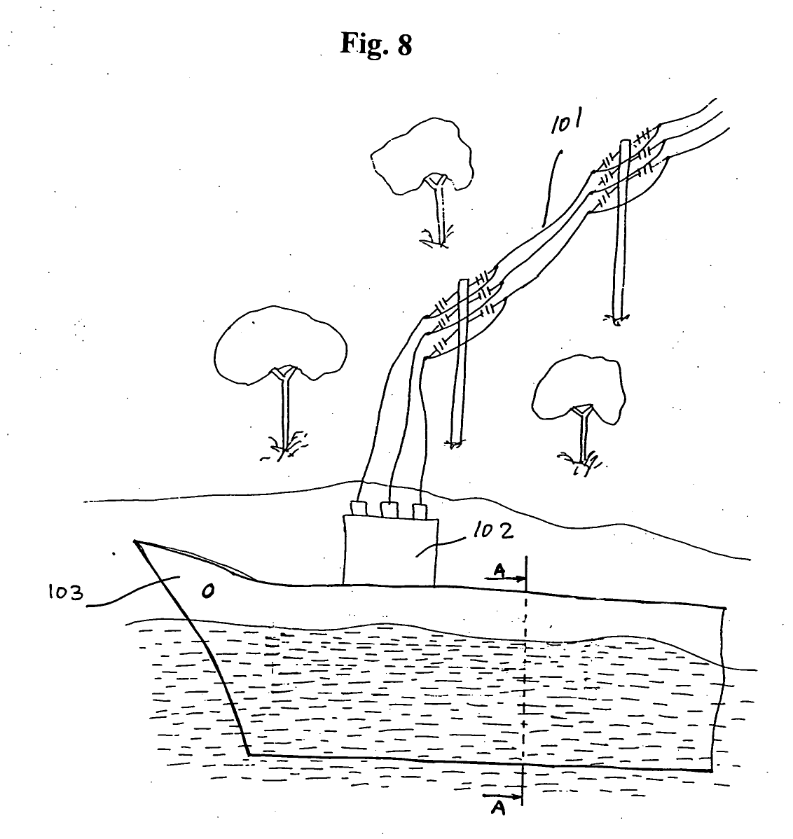

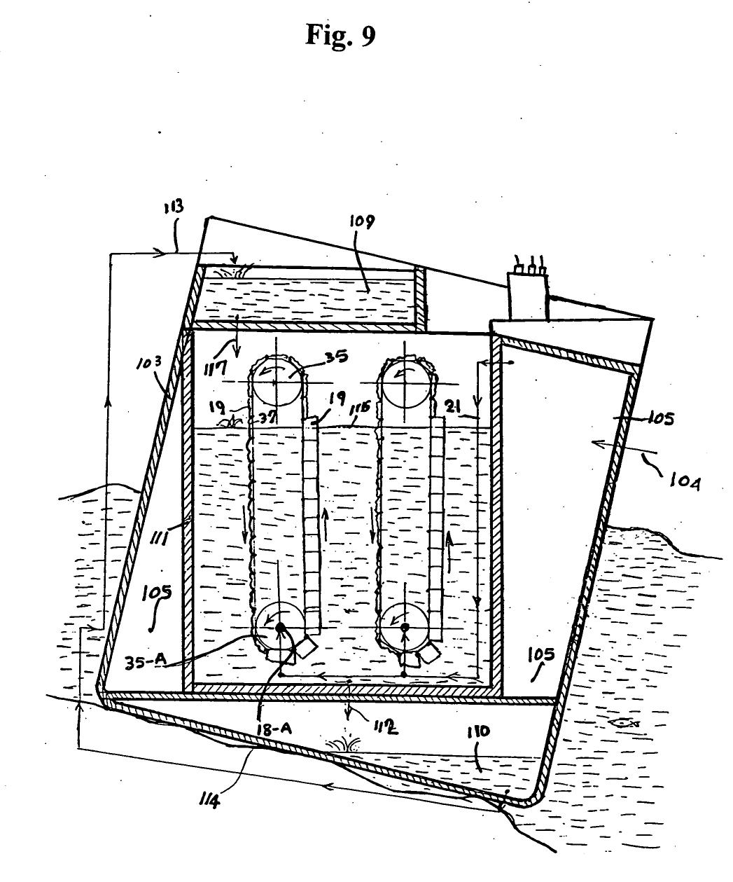

Under the tight cover A-3, and on the surface A-1 of the pool 1-A, the compressed air A-2 is now expended and its pressure A-4 has dropped the equivalent of the hydrostatic pressure of the column of water 125 of the pool 1-A. Then, the same expended air A-2 is forced to go through line A-7 to the ascending containers of power plant B through its own rotary transfer joint 18-A-B. The same thing happens in power plant B as in power plant A, where the compressed air volume in the ascending containers expends again at shallower depth all During the ascending run until the air is dumped on the surface B-1 of power plant B. The buoyant force in power plant B is equal to the weight of the water displaced by the total volume of the expended air in all the ascending containers of power plant B.

Under the tight cover B-3; the compressed air B-2 is now expended and its pressure B-4 have dropped the equivalent of the hydrostatic pressure of the column of water 125 of the pool 1-B. Then the same expended air B-2 is forced again into the ascending containers of power plant C through the line B-7 and the rotary transfer joint 18-A-C. The same thing happens once more to the compressed air by expending another time at shallower depth. And ounce again at the end of the ascending run, the expended compressed air is dumped on the surface C-1 of the pool 1-C of power plant C. The buoyant force in power plant C is equal to the weight of the water displaced by the total volume of the expended air in all the ascending containers of power plant C.

Under the tight cover C-3, the compressed air C-2 is now expended and its pressure C-4 has dropped another time the equivalent of the hydrostatic pressure of the column of water 125 of the pool 1-C. Then the same expended air C-2 is forced for the last time into the ascending containers of power plant E through the line C-7 and the rotary transfer joint 18-A-E. In this last power plant of the same series, the same thing happens to the compressed air by expending another time at shallower depth. And ounce more at the end of the ascending run the expended compressed air is dumped on the surface E-1 of the pool 1-E of power plant E into the atmosphere. The buoyant force in power plant E is equal to the weight of the water displaced by the total volume of the expended air in all the ascending containers of power plant E.

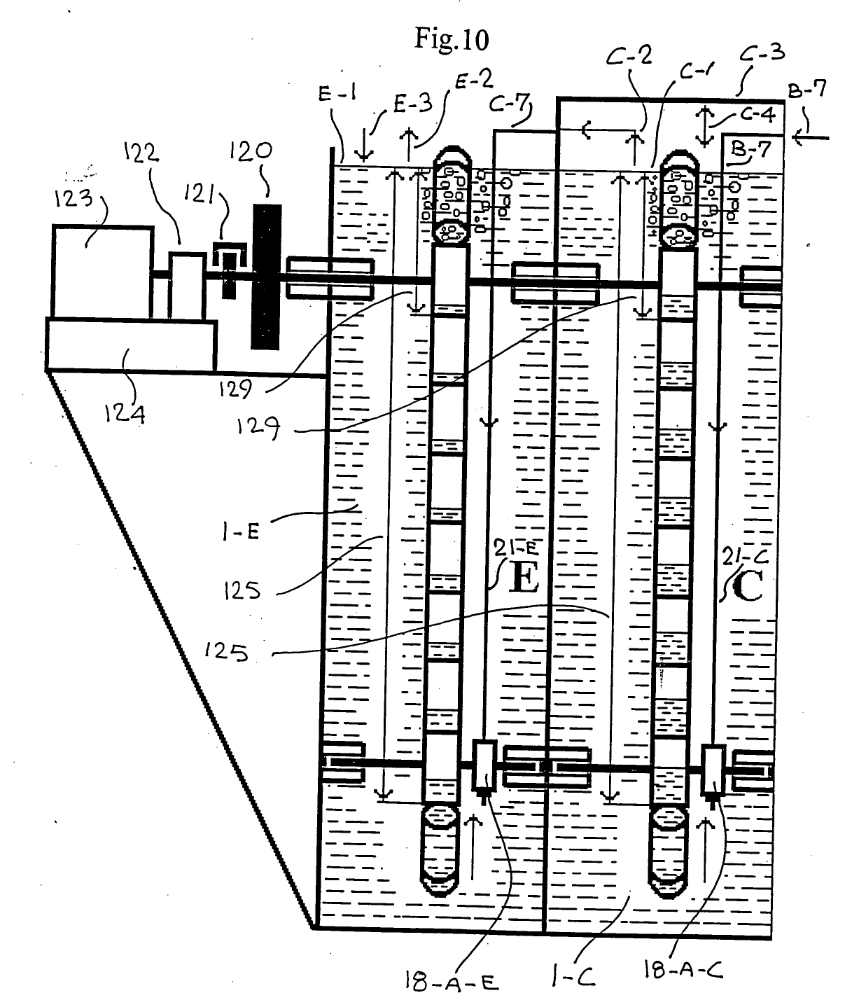

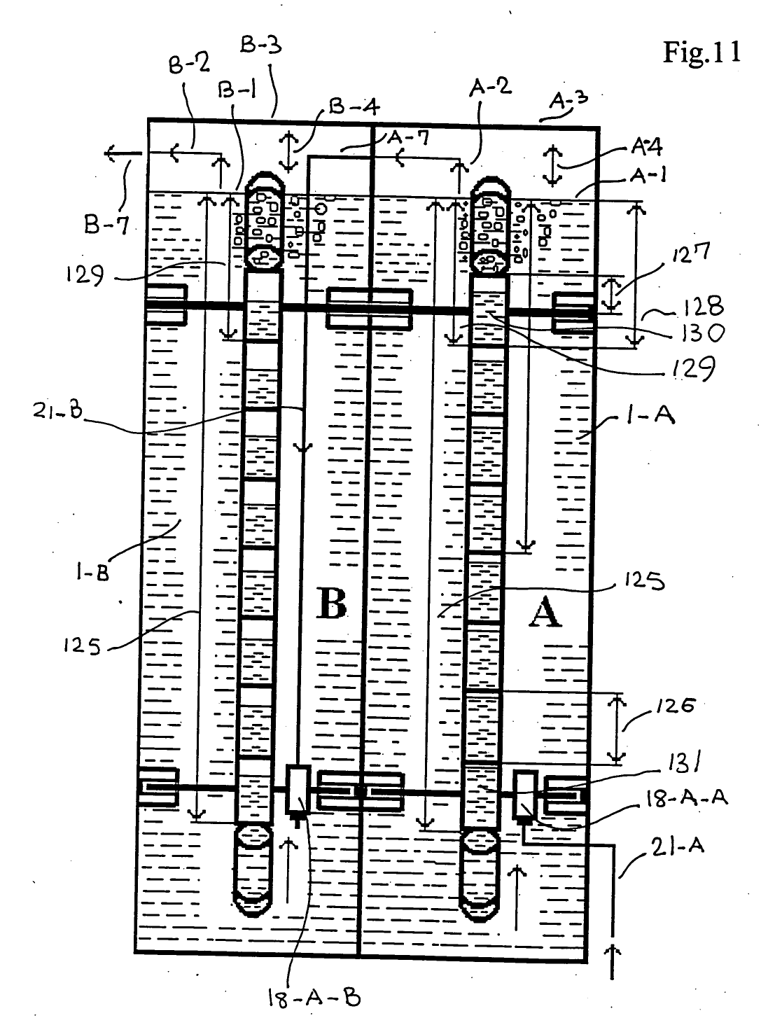

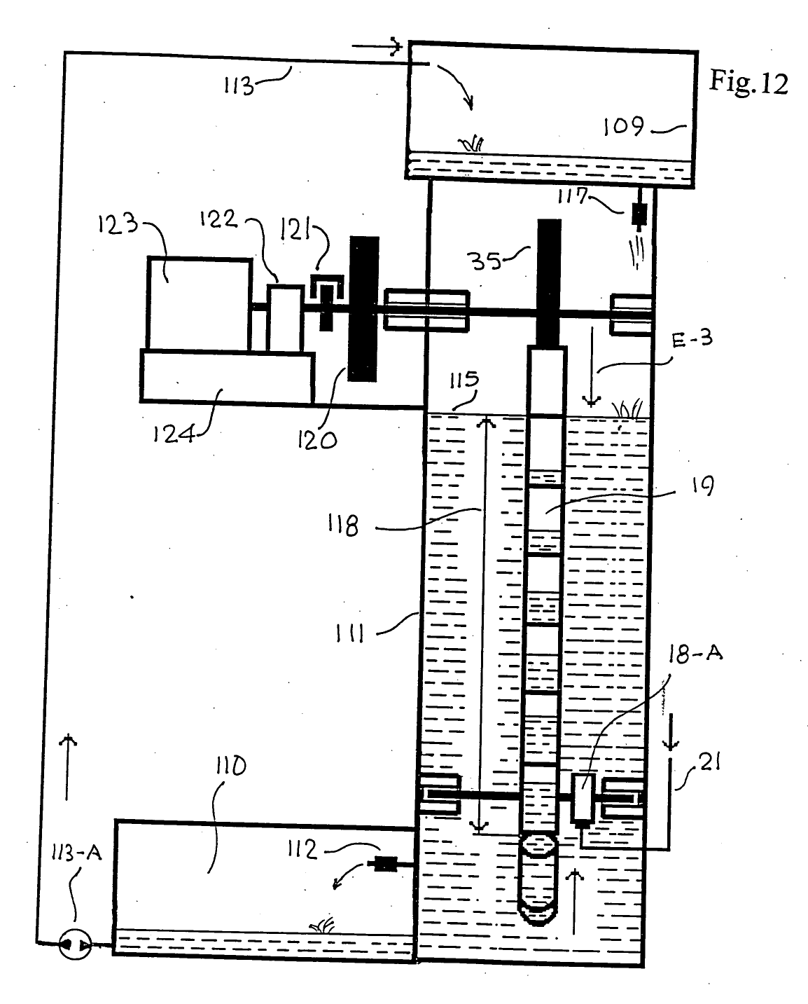

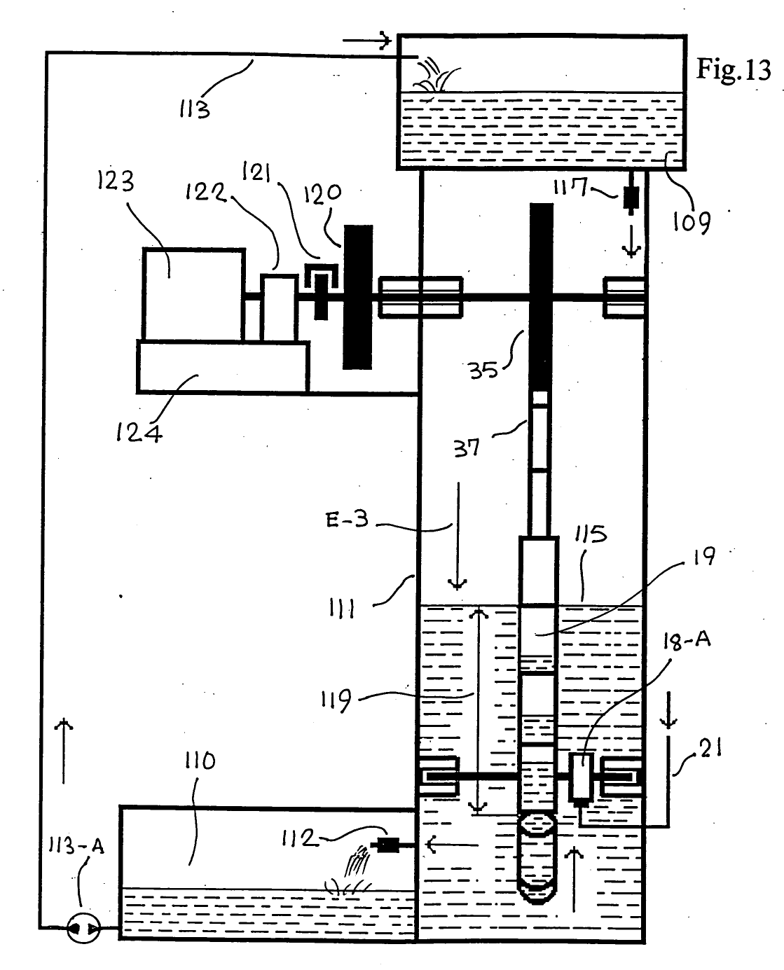

FIGS. 10 and 11 include power plant A, the pool 1-A, the depth 128 at the opening of the bottom vertical container 131 of the ascending containers (all the column of water between the surface of the pool and the opining of the bottom vertical containers of all power plants of this examples have the same depth), the rotary transfer joint 18-A-A, 8 ascending containers for every power plant, with equal length 126 and half length 127 (all the containers in this example have the same dimensions), the cover A-3, the pressure A-4 that is equal to the atmospheric pressure E-3 plus the hydrostatic pressure of the all the column of water of power plants B, C and E, the depth 128 at the opening of the upper vertical container 130 of the ascending containers (all upper vertical containers of all the power plants of this example are at the same depth). Power plant B, the pool 1-B, the rotary transfer joint 18-A-B, the cover B-3, the pressure B-4 that is equal to the atmospheric pressure E-3 plus the hydrostatic pressure of the all the column of water of power plants C and E, the air line A-7 that transfers the expended compressed air from power plant A to the rotary transfer joint 18-A-B of power plant B through line 21-B. Power plant C, the pool 1-C, the rotary transfer joint 18-A-C, the cover C-3, the pressure C-4 that is equal to the atmospheric pressure E-3 plus the hydrostatic pressure of the all the column of water of power plant E, the air line B-7 that transfers the expended compressed air from power plant B to the rotary transfer joint 18-A-C of power plant C through line 21-C, power plant E, the pool 1-E, the rotary transfer joint 18-A-E, the atmospheric pressure E-4, the flywheel 120, the Foucault current brake 121, the gearbox 122, the generator 123 and the frame 124 that supports the generator 123 and its gearbox 124.

FIG. 12 is a schematic representation of a power plant built in a recycled ship, showing a situation where the compressed air pressure is high, and a higher hydrostatic pressure is needed. It includes the pool 111, the driving shaft 132 that holds the driving wheel 35, the lower shaft 133 that holds the lower cogwheel 35-A, line 21 that transfer the compressed air from the air tank 105 to the rotary transfer joint 18-A, the flexible ascending containers 19, the high column of water 118, the water reservoir 110 that is built beneath the lower level where the water can rich in the pool when the waves are the lowest, in order to empty by gravity through valve 112 part of the water of the pool to get the appropriate hydrostatic pressure that permits the continuous injection of the compressed air into the ascending containers, which is necessary to keep running the power plant while producing the maximum amount of energy according to the actual situation, the hydraulic pump 113-A that is used to transfer the water from the lower water reservoir 110, to the higher water reservoir 109 that is built above the highest level, the water can rich in the same pool when the waves are the highest, through line 113, in order to fill up the pool by gravity, the needed quantity of water through valve 117, to get the appropriate column of water that gives the appropriate hydrostatic pressure, witch is necessary to keep running the power plant while producing the maximum amount of energy according to the actual situation, the flywheel 120, the Foucault current brake 121, the gearbox 122, the generator 123 and the frame 124 that supports the generator 123 and its gearbox 124,

FIG. 13 is a schematic representation of a power plant built in a recycled ship, showing a situation where the compressed air pressure is low, and a lower hydrostatic pressure is needed. It includes the pool 111, the driving shat 132 that holds the driving wheel 35, the lower shaft 133 that holds the lower cogwheel 35-A, line 21 that transfer the compressed air from the air tank 105 to the rotary transfer joint 18-A, the flexible ascending containers 19, the low column of water 119, the water reservoir 110 that is built beneath the lower level where the water can rich in the pool when the waves are the lowest, in order to empty by gravity through valve 112 part of the water of the pool to get the appropriate hydrostatic pressure that permits the continuous injection of the compressed air into the ascending containers, which is necessary to keep running the power plant while producing the maximum amount of energy according to the actual situation, the hydraulic pump 113-A that is used to transfer the water from the lower water reservoir 110, to the higher water reservoir 109 that is built above the highest level, the water can rich in the same pool when the waves are the highest, through line 113, in order to fill up the pool by gravity, the needed quantity of water through valve 117, to get the appropriate column of water that gives the appropriate hydrostatic pressure, witch is necessary to keep running the power plant while producing the maximum amount of energy according to the actual situation, the flywheel 120, the Foucault current brake 121, the gearbox 122, the generator 123 and the frame 124 that supports the generator 123 and its gearbox 124,

It should be understood, of course, that the foregoing disclosure relates to only a preferred embodiment of the invention, and that it is intended to cover all changes, and modifications of the example of the invention herein chosen, for the purposes of the disclosure, which do not constitute departures from the spirit and scope of the invention.

The result of this invention is to transform the potential energy of gases under any kind of high pressure more efficiently.

What I claim as my invention is:

1. A power plant comprising:
a number of hydroelectric plants connected in series, said power plant is driven by compressed air, each of said hydroelectric plant comprising
an airtight tank partially filled with water,
an endless chain rotating around upper and lower cogwheels and positioned inside said tank,
a plurality of containers attached to said chain at equal distances from each other,
control means to allow compressed air to be injected into each one of said containers in order to displace water out of said containers when each one of said containers is at the lowest point of its travel, wherein, after water is displaced out of said containers, each of said containers ascends towards the upper cogwheel due to buoyant force, where air is exhausted into enclosed space above water level is said tank and the container is again filled with water;
air supply means connected to said control means of a first of said hydroelectric plants,
means connecting said enclosed space to said control means of next hydroelectric plant so that air in said enclosed space is used to supply said next hydroelectric plant with compressed air.

2. A power plant as claimed in claim 1 wherein said power plant is constructed on a ship anchored close to the shore.

3. A power plant as claimed in claims 1 or 2 and characterised by:
a water tank placed under the lowest level the water can reach in the pool of the power plant, to permit to empty by gravity the water from the pool, in order to create the needed hydrostatic pressure for the good functioning of the power plant, when the height of the sea waves are low and the pressure of the compressed air is low.

4. A power plant as claimed in claims 3 and characterised by:
a water tank placed above the highest level the water can rich in the pool of the power plant, to permit to fill by gravity the pool, in order to create the needed hydrostatic pressure for the good functioning of the power plant, when the height of the sea waves are high and the pressure of the compressed air is high.

5. A power plant as claimed in claim 4 and characterised by:
a water pump to transfer the water from the lower tank to the higher tank, in order to create a closed circuit for all the volume of water used in the plant.

6. A power plant as claimed in claims 1, and characterised in addition by:
the installation of the upper cogwheel of the power plant that works with a fluctuating pressure of a flow of compressed air, out of the water of the pool at a higher level then the highest level the water can rich in said pool, in order to produce maximum energy out of any situation.

7. A power plant as claimed in claims 6, and characterised in addition by:
the use of flexible containers that permit to exit them out of the water of the pool in their ascending travel toward the upper cogwheel, and then to re-enter them in the water during their descending travel toward the lower cogwheel, without creating any major negative resistance that works against the working torque of said power plant.
